(19) United States
(12) Patent Application Publication
(10) Pub. No.: US 2006/0230178 A1
(43) Pub. Date: Oct. 12, 2006

(54) Method and apparatus for data transfer device

(76) Inventor: Philip Warren Trauring, Brookline, MA (US)

Correspondence Address: PHILIP TRAURING, 23 LEICESTER ST., BROOKLINE, MA, 02445, US

(21) Appl. No.: 11/087,822

(22) Filed: Mar. 24, 2005

(51) Int. Cl. G06F 15/16

(52) U.S. Cl. 709/237

(57) ABSTRACT

An apparatus and method for transferring data from storage and input devices, such as hard drives, digital cameras, scanners, audio devices and similar accessories to other storage devices or computer systems, like hard drives, removable disk storage devices, tape drives, compact-disc burners or any computer, via direct connection or by utilizing an intermediary communication device.

### FIELD OF THE INVENTION

This invention relates to electronic devices generally, and more specifically to a method and apparatus for transferring information between different types of devices.

### BACKGROUND OF THE INVENTION

As the number of devices that store data, either in analog or digital formats, grows with each successive year, the process of managing the data from these devices has become increasingly complex. Two primary problems arise in managing the data, first in how to transfer the data to suitable storage devices while away from a computer, and second the compatibility of the devices with computer systems and other peripheral devices.

One such class of devices, digital cameras, present a good illustration of the problems addressed by the present invention. Manufactured by several companies, they may include many different storage mediums, including, but not limited to, internal memory, hard drives, CompactFlash™ cards, SmartMedia™ cards, MultiMedia™ cards and Memory Stick™ media. In order to transfer the digital photos from the storage on the camera to a computer for processing, the user must either remove the storage card (when such a removable card is available) and insert it into a peripheral device for the computer that can read that card's format, or they need to plug the camera into the computer to transfer the pictures directly, assuming the camera has a method for connecting to the computer. When a user utilizes all the storage capacity of their camera and they are away from their computer, they need to either delete pictures taken on the camera or insert an additional storage card. Avoiding picture deletion requires either having extra storage cards, or access to a computer, when they are taking pictures. As these storage cards are in general much more expensive than disk media, it can be very expensive to keep enough cards around to store enough images. Some cameras also do not have removable storage media and once the internal storage is used up, the pictures must be removed before new pictures can be taken.

Another problem that arises with digital cameras is that the camera manufacturers generally need to create drivers for each computer operating system that they want the camera to be able to connect to for data transfer. As such, many companies only target the operating systems with the largest market share, basically eliminating users of other operating systems from using the camera in conjunction with their computer.

Some input devices have no storage included and rely entirely on a host computer to allow storage. One such device is a scanner. Also included in this category of devices are radios, which might not be designed to output directly to a computer, but can be recorded from by plugging the audio output from the radio into a computer or other apparatus's audio input port.

Although some devices exist which mitigate the some of the above mentioned problems, namely space and convenience limitations with a storage card, driver and operating system specificity limitations, and devices that have no storage capabilities at all, none of the devices currently available on the market alleviate the issues to the extent of the present invention.

### BRIEF DESCRIPTION OF THE DRAWINGS

The invention is better understood with the aid of description that follows and with reference to the appended drawings.

FIG. 1 is a schematic illustration of a data transfer between a digital camera and a hard drive, constructed and operative in accordance with the present invention.

FIG. 2 is a schematic illustration of a data transfer from a digital card reader to a remote storage device via a wireless modem, constructed and operative in accordance with the present invention.

FIG. 3 is a flow diagram illustration of the method of an input device connection constructed and operative in accordance with the present invention.

FIG. 4 is a flow diagram illustration of the method of an output device connection, constructed and operative in accordance with the present invention.

FIG. 5 is a flow diagram illustration of the method of a communications device connection, constructed and operative in accordance with the present invention.

### DESCRIPTION OF THE PREFERRED EMBODIMENTS

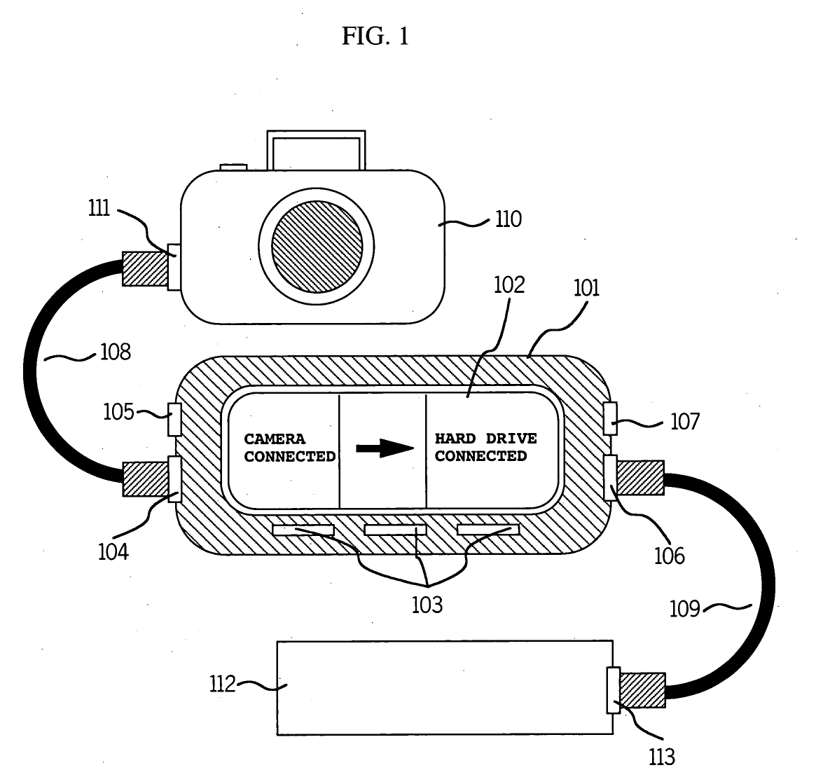

The present invention provides an apparatus that allows for the transfer of information from different types of storage and input devices to different types of storage devices and output devices, without the heed for a computer. In FIG. 1, to which reference is now made, the first preferred embodiment, a transfer storage device 101 is connected to an input device 110 via an input cable 108 and an output device 112 via an output cable 109. There may also be a display screen 102, a multiplicity of buttons 103, a multiplicity of connection ports 104, 105, 106 and 107 on transfer device 101, an input connection port 111 and an output connection port 113. Input device 110 may be a digital camera and output device 112 may be a hard disk, although these devices may be of a variety of input and output devices, respectively. Other such embodiments of input devices may comprise hard drives, scanners, removable storage devices, card readers and radio tuners. Other such examples of output devices may comprise compact-disc burners, removable storage devices, card readers, printers and computers and the like.

Cable 108 may be connected to input device 110 via a connector 111 and transfer storage device 101 via connector 104. Cable 109 is connected to output device 112 via a connector port 113 and to transfer storage device 101 via a connector port 106. Additionally shown are optional connectors 105 and 107, which may allow transfer storage device 101 to comprise additional input or output connector types. Persons skilled in the art will recognize that the connectors pictured can be replaced by wireless connections using radio frequency, infrared or other communications methods.

As shown in FIG. 1 transfer storage device 101 may also comprise an optional display screen 102 to display the status of connections and file transfers. Display 102 may also be a series of lights or audio feedback indicating status or could be left out of the apparatus design altogether. The apparatus may be controlled using a series of buttons 103. Buttons 103 are illustrated as three in number, but may be any number or even removed from transfer storage device 101, which may allow the operation of transfer storage device 101 to be automated or controlled through other means such as voice.

Transfer storage device 101 may be operated by connecting it to input device 110 and to output device 112, whereupon data contained in input device 110 may be transferred through transfer storage device 101 to output device 112. When input device 110 is initially connected to the transfer storage device 101, transfer storage device 101 may undertake to recognize if it supports the device. If transfer storage device 101 recognizes input device 110 and how to access the data on it, then it may indicate to the user that the device is ready to have data copied from it. If input device 110 is not recognized by transfer storage device 101 when connected, then it may indicate such to the user, allowing the user to either manually configure the device using control buttons 103 or to disconnect device 110.

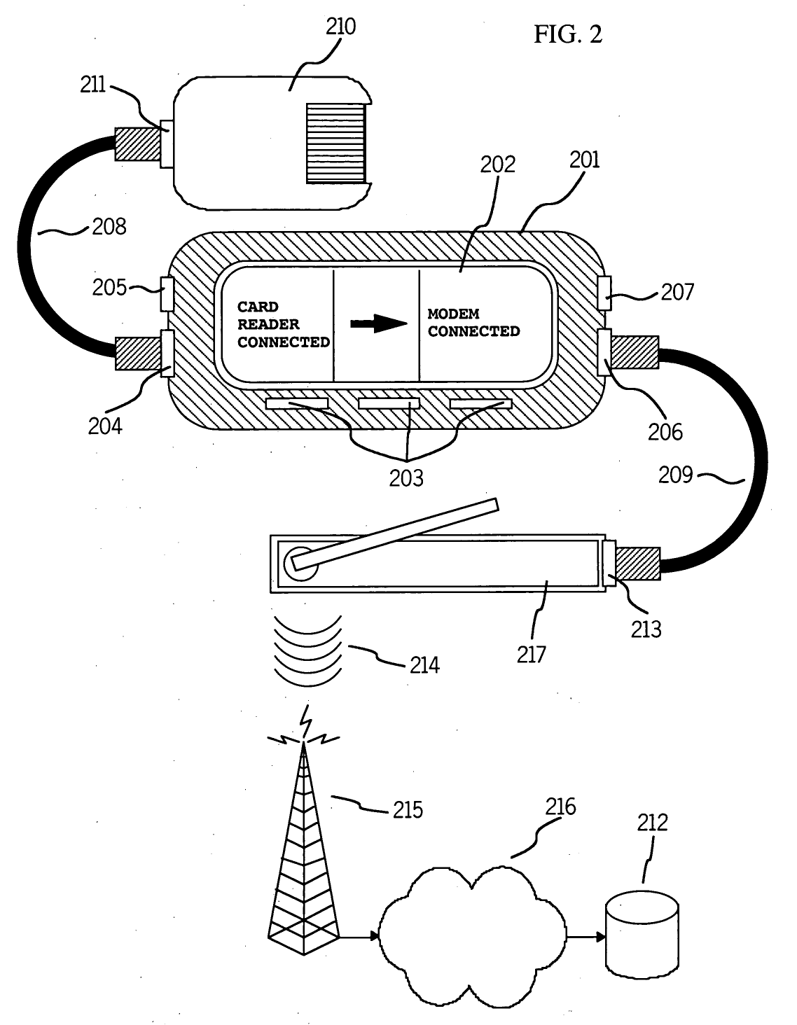

Reference is now made to FIG. 2, which describes a transfer storage device 201, which may be connected to an intermediary communications device 217, such as a wireless modem or cellphone. It will be appreciated that intermediary device 217 may be any type of wireless device. Transfer storage device 201 may be connected to an input device 210 via an input cable 208. There may also be a display screen 202, a multiplicity of buttons 203, a multiplicity of connection ports 204, 205, 206 and 207 on transfer device 201, an input connection port 211 and an output connection port 213. Intermediary device 217, which may be connected to transfer storage device 201 via a connector cable 209 may transmit data via radio waves 214 to a wireless base station 215, through a network cloud 216 in order to arrive at an output storage device 212. It will be appreciated that this process may also occur over a public network, such as the Internet, or locally via a small wireless base station hooked into a local area network.

Those skilled in the art will appreciate that the process shown could also be done completely in a wired environment, where device 217 may be an adapter that may allow the apparatus to connect to a wired network, which may therefore connect directly to network cloud 216 and to output storage device 212.

Use of transfer storage device 201 may be initiated by connecting to it input device 210 and output device 212. Alternately, one or both of the devices may be replaced by communications device 217 to handle connections to a remote device. In FIG. 2 this remote device is illustrated as output device 212, although it may be input device 210 that is remotely connected, with output device 212 being local.

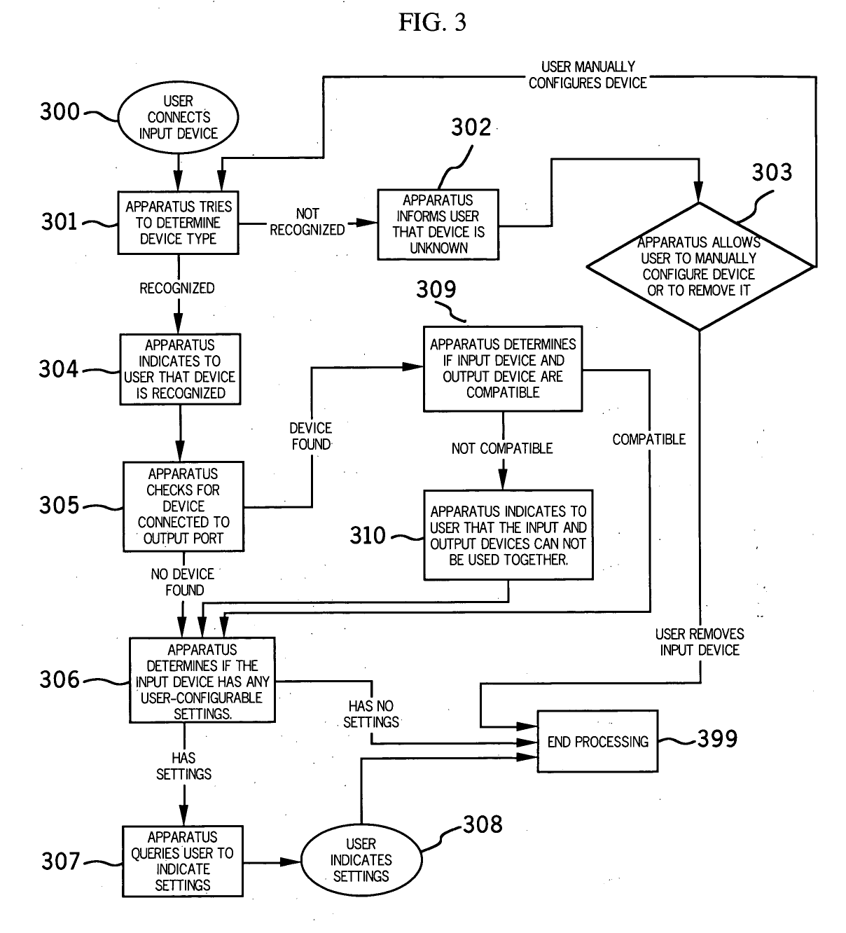

Reference is now made to FIG. 3, which illustrates the process initiated when an input device 110 (FIG. 1) may be connected to transfer storage device 101 of FIG. 1. In block 300, the user may connect input device 110 to transfer storage device 101. In block 301, transfer storage device 101 may undertake to determine the type of input device 110 to see if it may be supported. If the device is not recognized, then transfer storage device 101 may indicate to the user that device 110 is unknown 302, and may wait 303 for the user to either manually configure device 110, whereupon the transfer storage device 101 may return to the status of block 301, or the user may remove input device 110, whereupon the apparatus may then end processing 399.

If input device 110 is recognized by transfer storage device 101, device 101 may indicate to the user that device 110 is recognized 304 and then may check 305 to see if there is an output device 112 (FIG. 1) connected to the transfer storage device 101.

If there is no output device connected to the transfer storage device 101, then the device 101 may check 306 to see if there are any user-configurable settings for input device 110. If there are no user-configurable settings for device 110, then transfer storage device 101 may end processing 399. If there are user configurable settings for input device 110, then the transfer storage device 101 may request the user to specify settings 307 and may wait for the user to enter the settings 308 after which it may end processing 399.

If there is an output device 112 connected to transfer storage device 101, then device 101 may determine 309 if input device 110 and output device 112 are compatible. Examples of where devices might not be compatible include, but are not limited to, when the smallest piece of data on input device 110 is bigger than the total storage space on output device 112, or when input device 110 cannot output data fast enough for output device 112 to copy it. Those skilled in the art will recognize that there are other reasons devices might not be able to work together through transfer storage device 101.

If transfer storage device 101 finds that devices 110 and 112 are compatible then transfer storage device 101 may check 306 if there are user configurable settings for input device 110.

If transfer storage device 101 finds that devices 110 and 112 are not compatible, then device 101 may indicate 310 to the user that input device 110 and output device 112 may not be used together and may then go on to check 306 if there are user configurable settings for input device 110.

If there are no user-configurable settings for input device 110, then transfer storage device 101 may end processing 399. If there are user configurable settings for input device 110, then transfer storage device 101 may request the user to specify 307 settings and may wait for the user to enter 308 the settings after which it may end processing 399.

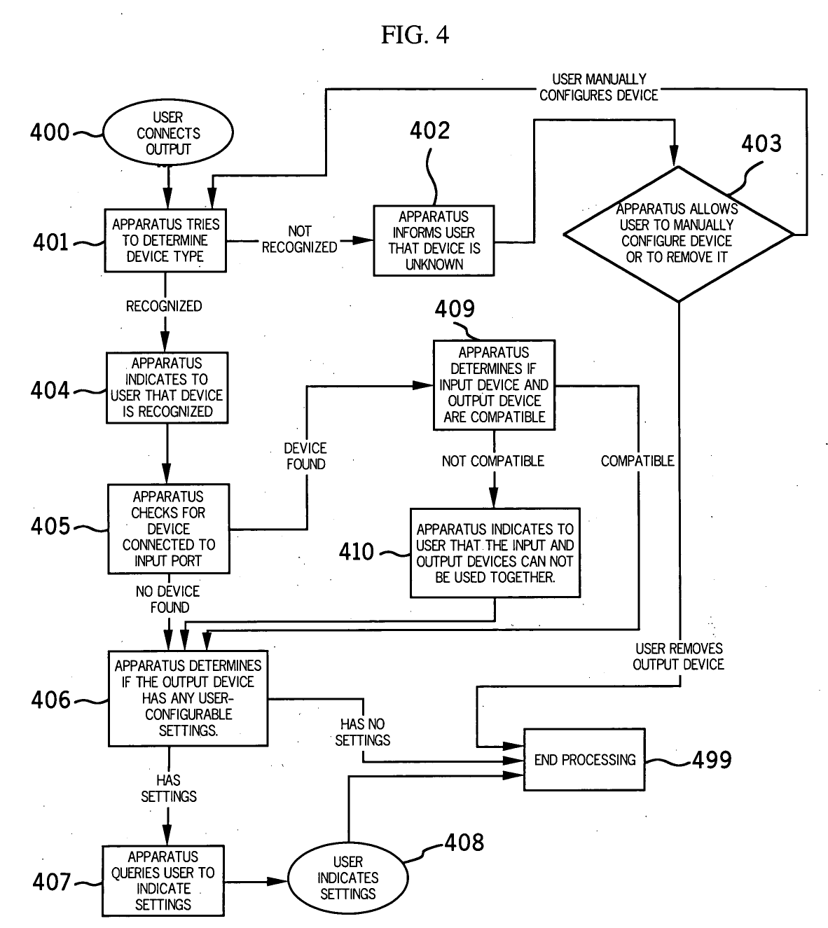

FIG. 4, to which reference is now made, illustrates the process initiated when output device 112 (FIG. 1) is connected to transfer storage device 101 (FIG. 1). In block 400, the user connects output device 112 to transfer storage device 101. In block 401, transfer storage device 101 may undertake to determine the device type to see if it is supported. If the device is not recognized, then transfer storage device 101 may indicate 402 to the user that device 112 is unknown, and may wait 403 for the user to either manually configure device 112, whereupon transfer storage device 101 may return to block 401, or may remove device, whereupon transfer storage device 101 may then end processing 499.

If output device 112 is recognized, transfer storage device 101 may indicate 404 to the user that it is recognized and may then check 405 to see if there is an input device connected to transfer storage device 101.

If there is no input device connected to transfer storage device 101, then transfer storage device 101 may check 406 to see if there are any user-configurable settings for output device 112. If there are no user-configurable settings for output device 112, then transfer storage device 101 may end processing 499. If there are user configurable settings for output device 112, then transfer storage device 101 may request the user to specify 407 settings and may wait for the user to enter the settings 408 after which it may end processing 499.

If there is an input device connected, then transfer storage device 101 may determine 409 if input device 110 and output device and output device 112 are compatible. Examples of where devices may not be compatible may include, but are not limited to, when the smallest piece of data on input device 110 may be bigger than the total storage space on output device 112, or when input device 110 may not output data fast enough for the output device to copy it. Persons skilled in the art will recognize that there may be other reasons two devices might not be able to work together through transfer storage device 101.

Transfer storage device 101 may find that input device 110 and output device 112 are compatible, in which case transfer storage device 101 may check 406 to see if there are user configurable settings for output device 112.

Alternatively, transfer storage device 101 may find that the devices are not compatible, in which case transfer storage device 101 may then indicate 410 to the user that input device 110 and output device 112 may not be used together and may then check 406 if there are user configurable settings for output device 112.

If there are no user-configurable settings for output device 112, transfer storage device 101 may then end processing 499. If user configurable settings are available for output device 112, transfer storage device 101 may then request 407 the user to specify settings and may wait for the user to enter the settings 408 after which it may end processing 499.

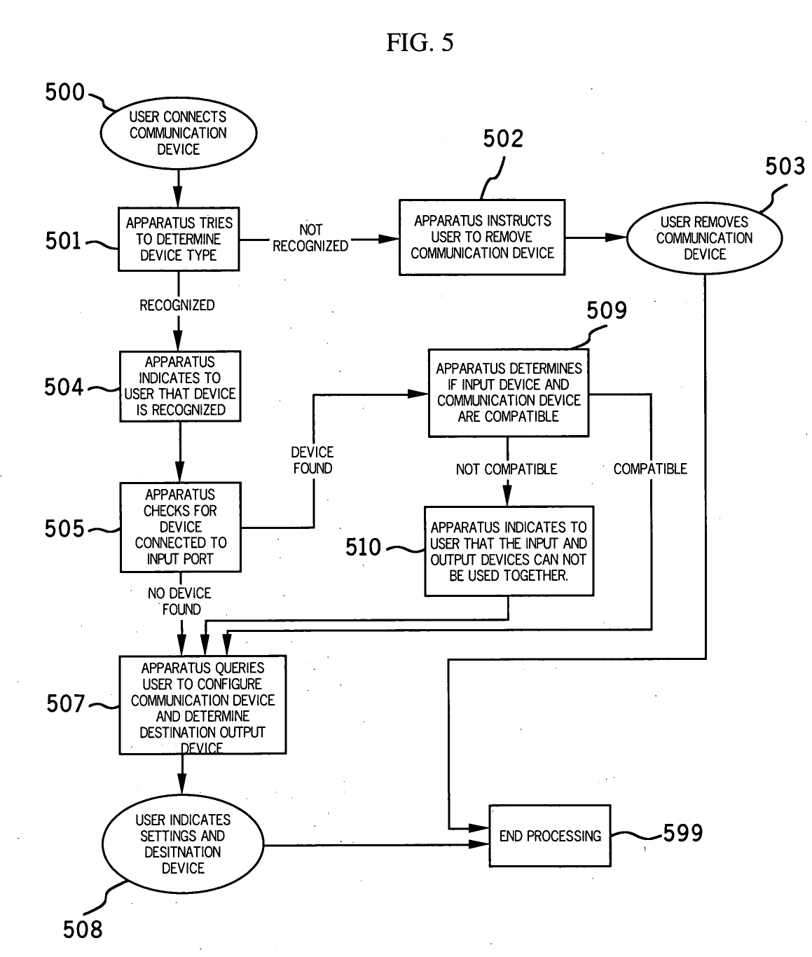

FIG. 5, to which reference is now made, illustrates the process initiated when communication device 217 (FIG. 2) is connected to the transfer storage device 201 (FIG. 2). Initially, the user may connect 500 communication device 217 to transfer storage device 201. Next, transfer storage device 201 may undertake to determine 501 the device type to see if it is supported. If communication device 217 is not recognized, transfer storage device 201 may then indicate to the user to remove 502 communication device 217, after which transfer storage device 201 may wait for the user to remove 503 communication device 217 and may then end processing 599.

If communication device 217 is recognized, transfer storage device 201 may indicate 504 to the user that it is recognized and may then check 505 to see if there is an input device connected to transfer storage device 201. In this example, communications device 217 has been plugged into output port 206, but it could easily have been plugged into input port 204, whereupon transfer storage device 201 at this point may be looking for an output device instead.

If there is no input device connected to transfer storage device 201, then transfer storage device 201 may request that the user specify settings 507 and may wait for the user to enter the settings 508 after which it may end processing 599.

If there is an input device 210 connected, then transfer storage device 101 may determine 509 if the input device 210 and output device 212 are compatible. Examples of where devices may not be compatible include, but are not limited to, if input device 210 cannot output data fast enough for communications device 217 to transmit it, or if input device 210 were to output data too fast for communication device 217 to transmit it. Those skilled in the art will recognize that there may be other reasons two devices might not be able to work together through transfer storage device 201.

Alternatively, transfer storage device 201 may find that input devices 210 and communications device 217 are compatible then transfer storage device 201 may request that the user specify settings 507 and may wait for the user to enter 508 the settings after which it may end processing 599.

If transfer storage device 201 finds that the devices are not compatible, then transfer storage device 201 may indicate 510 to the user that input device 210 and communication device 217 cannot be used together, then transfer storage device 201 may request that the user specify settings 507 for communications device 217 and may wait for the user to enter the settings 508 after which it may end processing 599.

Although the preferred embodiments of this invention include a dedicated hardware device, it is also possible for this invention to be implemented solely as software on a computer system, allowing the computer to act as transfer storage device 201 and the computer's input and output ports to act as the input and output ports for connecting devices. This would be helpful for quickly transferring data from one device to another without having to worry about getting the data on to the computer first, or to allow the user to utilize devices that are not normally compatible with their type of computer or with each other.

### SUMMARY OF THE INVENTION

The goal of the described apparatus and method is to act as an intermediary device that can transfer data from different types of storage and input devices to different types of storage devices, without needing to utilize a computer.

What is claimed is:

1. A method for transferring data between at least two separate devices,
the method comprising the steps of:
connecting the at least first device to an apparatus; and
the apparatus detecting what type of device has been connected; and
the apparatus confirming that the first device is a compatible device; and
connecting the second device to the apparatus; and
the apparatus detecting what type of device has been connected; and
the apparatus confirming that the second device is a compatible device; and
the apparatus transferring data from the first device to the second device.

2. The method of claim 1, where the at least first device is a storage device.

3. The method of claim 1, where the at least first device is an input device.

4. The method of claim 1, where the at least second device is a storage device.

5. The method of claim 1, where the at least second device is an output device.

6. The method of claim 5, where the output device is printer or other hard-copy producing device.

7. The method of claim 5, where the output device is a communications device that connects the apparatus to another storage device or output device.
